(19) United States
(12) Patent Application Publication
(10) Pub. No.: US 2022/0371918 A1
(43) Pub. Date: Nov. 24, 2022

(54) APPARATUS AND METHOD FOR CONTINUOUS SEPARATION OF SOLID PARTICLES FROM SOLID-LIQUID SLURRIES

(71) Applicant: The Board of Regents of the University of Oklahoma, Norman, OK (US)

(72) Inventors: Hamidreza Shabgard, Norman, OK (US); Ramkumar Parthasarathy, Norman, OK (US); Jie Cai, Norman, OK (US); Reza Kaviani, Norman, OK (US); Aly Elhefny, Norman, OK (US)

(73) Assignee: The Board of Regents of the University of Oklahoma, Norman, OK (US)

(21) Appl. No.: 17/750,113

(22) Filed: May 20, 2022

Related U.S. Application Data
(60) Provisional application No. 63/191,838, filed on May 21, 2021.
(60) Provisional application No. 63/233,894, filed on Aug. 17, 2021.

(51) Int. Cl. C02F 1/22; C02F 1/00

(52) U.S. Cl. CPC C02F 1/22; C02F 1/001

(57) ABSTRACT

A water treatment system is configured to remove salt from a feed brine. The water treatment system includes a primary freezing chamber configured to receive the feed brine and a source of cooled intermediate cold liquid connected to the primary freezing chamber. The cooled intermediate cold liquid and feed brine are mixed within the primary freezing chamber, where ice particles are formed. The water treatment system includes a rotary separator connected to a discharge from the primary freezing chamber. The rotary separator is configured to separate solid ice particles from liquid components in the discharge from the primary freezing chamber. In some embodiments, the rotary separator includes a mesh inner filter tube that is configured for rotation within a solid outer filter tube, where the mesh inner filter tube allows liquid components to drain into the outer filter tube while conveying solid ice particles to an ice recovery tank.

### RELATED APPLICATIONS

The present application claims the benefit of U.S. Provisional Patent Application Ser. No. 63/191,838 filed May 21, 2021 and entitled, “(2021-052) Apparatus and Method for Continuous Separation of Solid Particles from Solid-Liquid Slurries, and U.S. Provisional Patent Application Ser. No. 63/233,894 filed Aug. 17, 2021 and entitled, “Apparatus and Method for Continuous Separation of Solid Particles from Solid-Liquid Slurries,” the disclosures of which are both incorporated by reference as if fully set forth herein.

### STATEMENT OF GOVERNMENT FUNDING

This invention was made with government support under Grant Number DE-AR0001069 awarded by ARPA-E of the U.S. Department of Energy. The government has certain rights in the invention.

### BACKGROUND

Fresh water resources are becoming increasingly scarce due to diminishing resources and increasing consumption. At the same time, wastewater management imposes a challenge in various municipal and industrial sectors. As an example, the oil and gas industry consumes large volumes of fresh water during the recovery of hydrocarbons while producing large volumes of wastewater that is contaminated with a variety of minerals, heavy metals, and organic compounds. Modern oil and gas extraction techniques, including hydraulic fracturing, produce particularly large volumes of contaminated wastewater.

Management of the produced water presents a significant challenge to the industry due to the limitations of existing treatment technologies and the potential negative environmental impacts of releasing insufficiently treated water to the environment. Currently, produced wastewater from oil and gas operations is often injected into deep disposal wells, which raises concerns over drinking water contamination and potential seismic implications. The increasing demand and decreasing availability of fresh water presents a significant concern to the economy and the environment.

Most produced water is a salt brine that is dominated by sodium chloride. Various technologies have been developed for water desalination and purification over past several decades. The commercially available desalination techniques can be grouped into two main categories: membrane desalination (reverse osmosis and forward osmosis) and thermal desalination (multi-stage flash and multi-effect desalination). Reverse osmosis is a form of pressurized filtration in which the filter is a semi-permeable membrane that allows water to pass through. Membrane-based seawater desalination is presently limited by significant specific energy consumption, high unit costs, and environmental impacts including greenhouse gas emissions and organism impingement through intakes. Multi-stage flash came into practice in the early 1960s and became popular due to its reliability and simplicity. The most important disadvantage of multi-stage flash is the relatively higher energy consumption which renders multi-stage flash competitive only when energy costs are very low.

The other major thermal desalination technology is multi-effect distillation which consists of a series of stages in which evaporation and condensation occur in a decreasing pressure (temperature) order. The heat of condensation of steam in each stage is recovered to generate more steam at a lower pressure and temperature. Compared to multi-stage flash, the significant increase in heat transfer area in the multi-stage distillation in addition to the thermodynamic superiority results in a very low temperature drop per stage/effect (1.5-2.5° C.). As such, multi-stage distillation systems are able to incorporate a large number of effects of 8-16 in typical large plants. The performance ratio is generally higher than the multi-stage flash systems. Unlike multi-stage flash, the multi-effect distillation process usually operates as a once-through system and the absence of recirculation of large brine masses significantly reduces pumping requirements.

Currently, both thermal and membrane based desalination technologies are best suited for water sources with relatively low total dissolved solids (TDS), with typical salt concentrations less than 70,000 ppm. In fact, the majority of the desalination plants are designed for treatment of seawater. As such, the application of the existing commercially available membrane-based and thermal desalination technologies to water sources with higher TDS concentrations will lead to operational problems such as fouling and corrosion, as well as lower efficiencies.

In contrast, freeze-desalination processes are naturally well suited for such low quality feed streams because pure ice (water) crystals can be produced even in highly concentrated brines. Currently, there are three major freeze-desalination technologies, namely: direct-contact; indirect-contact; and vacuum freezing desalination. However, each of these technologies has its own deficiencies which hinders their widespread use compared to thermal and membrane based desalinization methods.

In direct contact systems, a liquid refrigerant is injected into the brine and freezing occurs as the refrigerant absorbs heat from the brine upon vaporization. Direct contact freezing offers very large heat transfer coefficients; however, the purified water contains excessive amounts of refrigerant that are hard to separate due to hydrate formation. In indirect contact systems, a solid surface separates the refrigerant from the brine, thereby preventing the diffusion of the refrigerant into the purified water. Several indirect contact systems have been developed including layer growth freezing on stationary or rotating surfaces, dynamic layer growth, and suspension crystallization. However, each of the above methods has its own deficiencies. The layer growth systems require large equipment volumes and complex moving mechanisms to resolve the slow crystallization rate and to facilitate ice separation from the cold surfaces. The major drawbacks of the dynamic layer growth systems are large system size and entrainment of the salts in the ice resulting in low quality purified water. The suspension freeze systems suffer from lack of effective control of nucleation and complex system design.

The vacuum freeze systems use the cooling effect of evaporating water under vacuum to create ice formation, where evaporation and freezing occur simultaneously. However, the compression of low pressure and low density vapor in the vacuum freeze systems requires a significant amount of energy that negatively impacts the economy of vacuum freeze desalination. Moreover, in vacuum freeze systems, the diffusion of dissolved gases from the brine into the vapor usually leads to reduced water quality.

In view of the deficiencies in the current desalination and wastewater processing technologies, there is a significant need for a desalination technology capable of handling highly concentrated water with acceptable energy efficiency and cost-competitiveness.

### BRIEF DESCRIPTION OF THE DRAWINGS

FIG. 1 is a functional block diagram of a freeze-spray system constructed in accordance with a first embodiment.

FIG. 2 is a functional block diagram of a freeze-spray system constructed in accordance with a second embodiment.

FIG. 3 is a side cross-sectional view of a two-component rotary separator.

FIG. 4 depicts the movement of ice particles through the two-component rotary separator of FIG. 3.

FIG. 5 is a side cross-sectional view of a multi-component rotary seprator.

### WRITTEN DESCRIPTION

The present disclosure, in at least one non-limiting embodiment, discloses an innovative zero-liquid discharge, intermediate-cold-liquid eutectic-freeze desalination system. The system, in one embodiment, includes two main components: a spray freezing section and an ice-liquid separation apparatus. In some embodiments, ice-liquid separation apparatus includes a rotary separator that includes a screened inner cylinder that rotates within an outer cylinder. The use of the separation apparatus is not limited to desalination but can be employed in any capacity to separate particles, objects, or solid materials from a solid-liquid slurry.

Generally, the separation apparatus can be used in a variety of industries and for a variety of purposes, including, but not limited to, (1) water desalination (desalinization), (2) concentrating food liquids by removing ice from the food liquids, (3) biofuel and animal feed industries, (4) removal of solids from waste waters and slurries produced by, for example, municipal sewage treatment plants and mining operations, (5) purification of raw materials produced by the petrochemical, semiconductor, and mining industries, and (6) use by the steel industry to dissolve materials and purify waste materials.

Before further describing various embodiments of the present disclosure in more detail by way of exemplary description, examples, and results, it is to be understood that the embodiments of the present disclosure are not limited in structure and application to the details as set forth in the following description. The embodiments of the present disclosure are capable of being practiced or carried out in various ways not explicitly described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so.

Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the present disclosure has been described in terms of particular embodiments, it will be apparent to those of skill in the art that variations may be applied to the apparatus and/or methods and in the steps or in the sequence of steps of the methods described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entirety to the same extent as if the contents of each individual patent or publication was specifically and individually incorporated herein. More particularly, the present disclosure expressly incorporates by reference the entirety of U.S. Provisional Patent Application Ser. No. 62/933,932, filed Nov. 11, 2019 entitled, “Zero Liquid Discharge Eutectic Freeze Desalination with Intermediate Cold Liquid,” and the entirety of U.S. patent application Ser. No. 17/095,675, filed Nov. 11, 2020, also entitled, “Zero Liquid Discharge Eutectic Freeze Desalination with Intermediate Cold Liquid.”

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the apparatus, methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the terms “at least one” or “plurality” will be understood to include one as well as any quantity more than one, including but not limited to, 2, 3, 4, 5, 6, 7, 8, 9, 10, 15, 20, 30, 40, 50, 100, or any integer inclusive therein, and/or any range described herein. The terms “at least one” or “plurality” may extend up to 100 or 1000 or more, depending on the term to which it is attached; in addition, the quantities of 100/1000 are not to be considered limiting, as higher limits may also produce satisfactory results. In addition, the use of the term “at least one of x, y, and z” will be understood to include x alone, y alone, and z alone, as well as any combination of x, y, and z.

Where the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “a, b, c, or combinations thereof” is intended to include at least one of: a, b, c, ab, ac, bc, or abc, and if order is important in a particular context, also ba, ca, cb, cba, bca, acb, bac, or cab. Continuing with this example, expressly included are combinations that contain repeats of one or more item or term, such as bb, aaa, aab, bbc, aaabcccc, cbbaaa, cababb, and so forth. The skilled artisan will understand that typically there is no limit on the number of items or terms in any combination, unless otherwise apparent from the context.

Throughout this application, the terms “about” and “approximately” are used to indicate that a value includes the inherent variation of error for the composition, the method used to administer the composition, or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The terms “about” or “approximately”, where used herein when referring to a measurable value such as an amount, a temporal duration, thickness, width, length, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 75% of the time, at least 80% of the time, at least 90% of the time, at least 95% of the time, or at least 98% of the time.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-30 therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, as well as sub-ranges within the greater range, e.g., for 1-30, sub-ranges include but are not limited to 1-10, 2-15, 2-25, 3-30, 10-20, and 20-30. Reference to a range of 1-50 therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, etc., up to and including 50. Reference to a series of ranges includes ranges which combine the values of the boundaries of different ranges within the series. Thus, to illustrate reference to a series of ranges, for example, a range of 1-1,000 includes, but is not limited to, 1-10, 2-15, 2-25, 3-30, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 1 mm to 10 m therefore refers to and includes all values or ranges of values, and fractions of the values and integers within said range, including for example, but not limited to, 5 mm to 9 m, 10 mm to 5 m, 10 mm to 7.5 m, 7.5 mm to 8 m, 20 mm to 6 m, 15 mm to 1 m, 31 mm to 800 cm, 50 mm to 500 mm, 4 mm to 2.8 m, and 10 cm to 150 cm. Any two values within the range of 1 mm to 10 m therefore can be used to set lower and upper boundaries of a range in accordance with the embodiments of the present disclosure.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

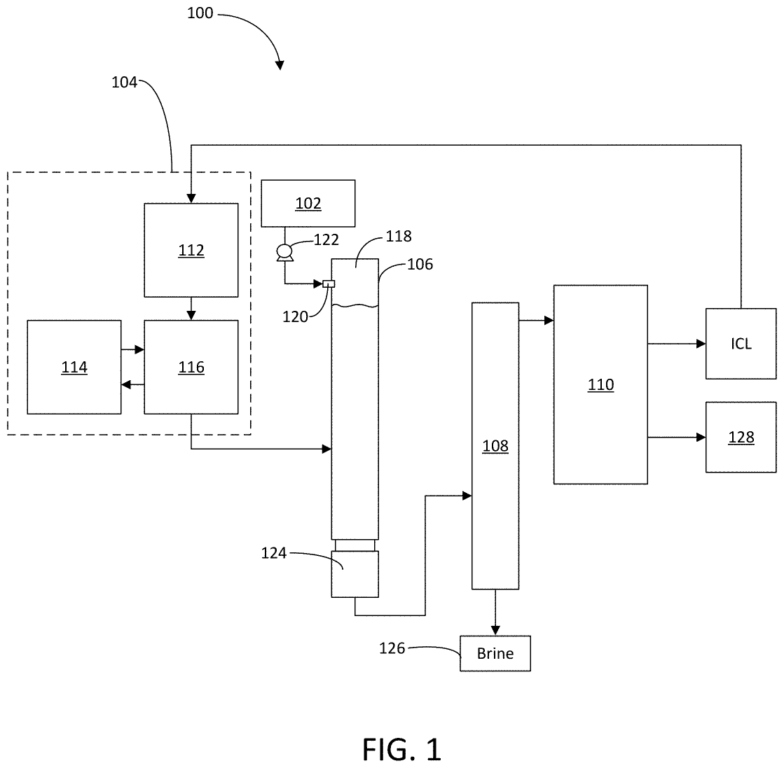

Turning to FIG. 1, shown therein is a functional block diagram illustrating an inventive water treatment process 200 carried out in accordance with an exemplary, non-limiting, embodiment of a water treatment system 100. Generally, the treatment process 200 makes use of a water-immiscible intermediate-cold-liquid (ICL) to freeze brine, which is then separated from the ice, precipitated salts and remaining liquid brine. The ice can be melted to produce purified water, while the ICL is separated from brine and recirculated and cooled through a refrigeration cycle. The system can be operated in both “zero-liquid” output mode, in which the only liquid produced by the system is purified, desalinated water, or partial freeze mode, where a fraction of the water in the input brine is recovered by freezing. In zero-liquid output operation, salt and other contaminants are removed from the system as solids for facilitated disposal or downstream processing.

In the embodiment depicted in FIG. 1, the treatment system 100 generally includes a brine feed source 102, a refrigerated ICL source 104, a primary freezing chamber 106, a primary separator 108, and a settling tank 110. Although the exemplary embodiments are not so limited, the brine feed source 102 can supply a brine with total dissolved solids (TDS) within the range of 5,000 to 300,000 ppm.

The ICL source 104 includes an ICL tank 112 that contains a suitable, refrigerated ICL. Suitable ICLs include silicone-based fluids that are immiscible with water and present low health, safety and environmental risks. Some main classes of stable coolants that are liquids at a room temperature include aromatics (HC), silicate-ester (SE), aliphatics (PAO), silicones, and fluorinated liquids (PFC, PFE, HFE, FK). In some applications, segregated hydrofluoroethers (HFEs) available from the 3M Company as Novec 7000-series fluids can be used as the ICL.

The ICL is cooled with a refrigeration module 114 and heat exchanger 116. The ICL can be cooled “on demand” as it passes through the heat exchanger 116, which transfers heat to refrigerated coolant in an evaporator section of the refrigeration module 114. In other embodiments, the ICL is cooled within the ICL tank 112 through a continuous heat exchange through the heat exchanger 116. In some applications, the ICL is cooled using solar-driven absorption ammonia refrigeration, which permits refrigeration of the ICL without connection to an established electrical grid. In each case, the ICL is cooled to about −30° C. in exemplary, non-limiting embodiments.

The cold ICL leaving the heat exchanger 116 or ICL tank 112 is introduced to the primary freezing chamber 106. In exemplary embodiments, the primary freezing chamber 106 is a concentric double-cylinder with an insulated annular space between the two cylinders. The liquid level inside primary freezing chamber 106 can be maintained at level that provides a headspace 118 near the top of the primary freezing chamber 106 above the liquid column. In some configurations, the liquid level is maintained within the primary freezing chamber 106 at a level that is between 50-90% of the total height of the primary freezing chamber 106, with the balance of the primary freezing chamber 106 assigned to the headspace 118. In some embodiments, the liquid level within the primary freezing chamber 106 is maintained at about 80% of the total height of the primary freezing chamber 106.

The primary freezing chamber 106 includes a brine injection nozzle 120 that is configured to deliver brine from the feed brine source 102 into the headspace 118. The brine injection nozzle 120 is optimally positioned just above the liquid level within the primary freezing chamber 106. In a non-limiting example, in a primary freezing chamber 106 that is about 1 meter tall, the liquid level inside the primary freezing chamber 106 can be about 0.8 meters deep, with a headspace of about 0.2 meters above the top of liquid column, and with the brine injection nozzle positioned about 2 centimeters above the top of the liquid column in the headspace 118. The temperature of the primary freezing chamber 106 can be maintained between −5° C. and −25° C. for optimal performance in some applications, with a narrower range of −5° C. and −25° C. in other applications.

Brine from the feed brine source 102 is injected through the brine injection nozzle 120 into the headspace 118 of the primary freezing chamber 106. A brine pump 122 can be used to increase the pressure of the feed brine between the feed brine source 102 and the brine injection nozzle 120. In the primary freezing chamber 106, cold ICL absorbs thermal energy from the brine, while maintaining immiscibility with the brine. The average temperature within the main crystallization tank 106 is maintained within a range of −5° C. to −30° C. depending on the TDS of the input brine and the desired freshwater recovery ratio by adjusting the flow rate of the cold ICL relative to the untreated input brine.

In some embodiments, the ICL flow rate is an order of magnitude greater than the brine flow rates entering the primary freezing chamber 106. In some applications, the primary freezing chamber 106 includes a paddle, stirrer or other agitation system that encourages good mixing between the ICL and the brine. In other applications, the primary freezing chamber 106 is configured such that the injection of the ICL and brines produces sufficient mixing without additional agitation.

As the injected ICL comes in contact with the brine, both salt and ice crystals form. The ice-ICL-salt-brine mixture is pumped or otherwise moved out of the bottom portion of the primary freezing chamber 106. Within the salt-ICL slurry, the brine component may be present completely or partially as hydrohalite crystals. The lighter ice-brine slurry is a mixture of purified water ice crystals carried in a brine solution. The primary freezing chamber 106 optionally includes an ice grinder 124 at the bottom of the primary freezing chamber 106. The ice grinder 124 includes a motor and a series of blades, paddles or intermeshing gears that reduce the size of the ice particles and any other solid particles. The ice grinder 124 crushes larger chunks of ice and creates fine ice particles that can easily flow with the ICL and other liquid constituents (including unfrozen liquid brine) as an ice-liquid-salt slurry out of the primary freezing chamber 106.

The ice-liquid-salt slurry flows from the ice grinder 124 to the primary separator 108. The primary separator 108 can be configured as a vertical column. The main purpose of the primary separator 108 is to separate the unfrozen injected brine and solid salts and salt-hydrates from ice-ICL portion of the slurry. Within the primary separator 108, the ice particles and ICL move upward despite the relatively larger density of ice as compared to the ICL, due to the relatively large flow velocities in the column that create a hydrodynamic force greater than the gravity force. The ice-ICL slurry leaves the primary separator 108 from a top outlet and flows to the settling tank 110.

The balance of the slurry entering the primary separator 108, including salt crystals and unfrozen concentrated liquid brine, flows out of the bottom of the primary separator 108 to a brine discharge line 126. The concentrated liquid brine can be transferred from the brine discharge line 126 to downstream storage facilities or processing facilities, injected into subterranean reservoirs, or partially or completely recirculated back to the feed brine source 102 for additional treatment under the method 200.

The settling tank 110 facilitates the separation of the ICL from the ice particles. As the ice particles melt, the differences between the densities of the ICL and the purified water form a two-layer system in which the lighter ICL floats on top of the heavier water. The ICL can be drawn off the top of the settling tank 110 and recirculated to the ICL tank 112, while the purified water can be drawn off the bottom of the settling tank 110 and delivered to a water discharge line 128. The water discharge line 128 can be connected to downstream storage or processing facilities, or made available for immediate use through a variety of applications.

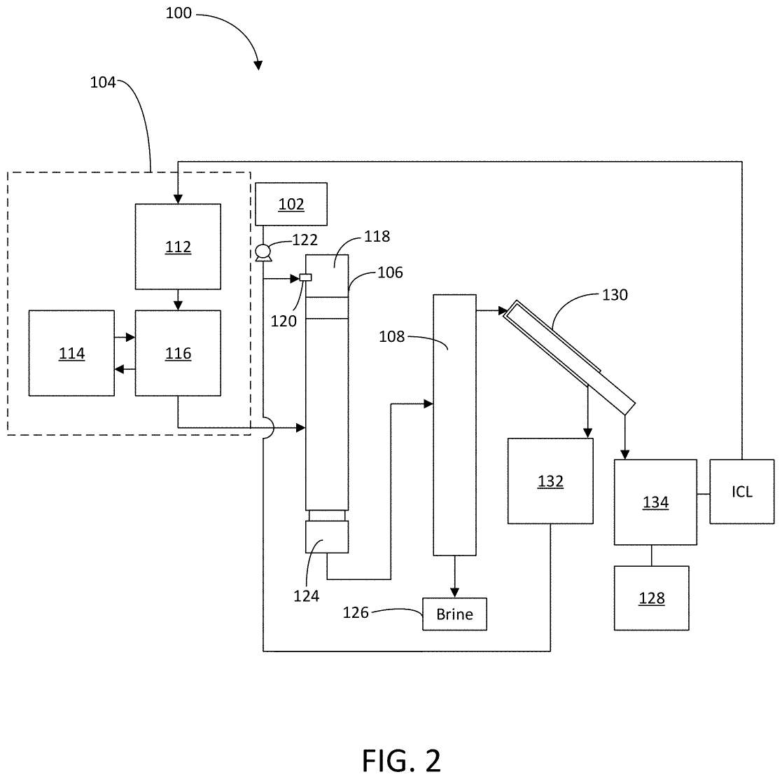

Turning to FIG. 2, shown therein is another embodiment of the water treatment system 100. In the embodiment depicted in FIG. 2, a rotary separator 130 has been connected to the ice-ICL discharge from the primary separator 108. In other embodiments, the rotary separator 130 can be connected directly to the outlet of the primary freezing chamber 106. The rotary separator 130 provides an efficient mechanical means for accelerating and improving the separation of liquid-phase ICL from solid-phase ice. Liquid ICL is deposited in an ICL recovery tank 132, while solids are deposited in an ice recovery tank 134. The solids deposited in the ice recovery tank 134 are primarily ice particles, which may be coated with ICL. The ICL can be separated from the melting ice in the ice recovery tank 134, which discharges purified water from the melting ice through the water discharge line 128. Recovered liquid ICL can be recirculated to the ICL tank 112.

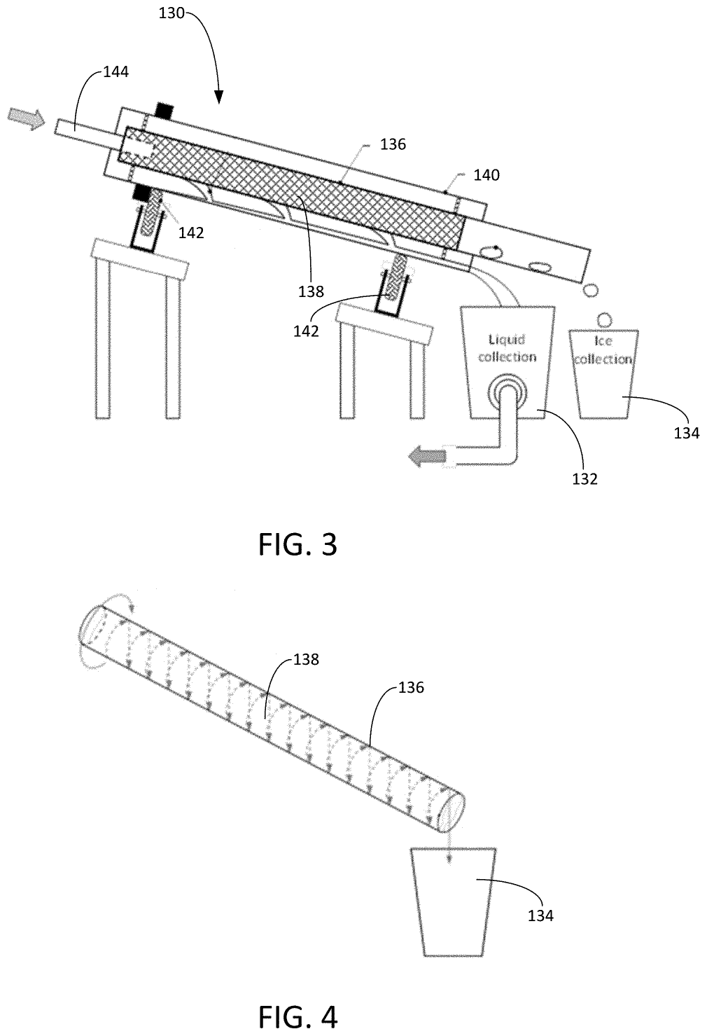

As illustrated in FIG. 3, the rotary separator 130 is generally configured as a trommel screen and configured to separate materials based on particle size. The rotary separator 130 includes an inner filter tube 136 that includes a mesh wall 138 that rotates within an outer housing 140 that is configured to capture liquid discharged through the mesh wall 138 of the inner filter tube 136. The inner filter tube 136 and outer housing 140 can be cylindrical or configured with a non-circular cross-sectional shape (e.g., triangular, rectangular, pentagonal, hexagonal, octagonal, etc.). The inner filter tube 136 and outer housing 140 may not have the same cross-sectional shape, but the inner filter tube 136 and outer housing 140 should each be configured to permit the rotation of the inner filter tube 136 within the outer housing 140.

In non-limiting embodiments, the sizes or diameters of the apertures or pores of the mesh wall 138 may be in a range of 1μ to 10μ to 100μ to 1 mm to 10 mm to 25 mm to 50 mm to 100 mm or larger, depending on the type of solid that occurs in the slurry that is being passed through the inner filter tube 136 of the rotary separator 130. Any material that retains solid particles of a selected size while allowing liquid to pass through the inner filter tube 136 can be used as the material for the mesh wall 138. Examples include fiberglass mesh, fabric, metal screen mesh, and slotted or perforated metallic or plastic tubes.

The rotary separator 130 is normally oriented at an incline such that an inlet 144 to the rotary separator 130 is higher than the outlet from the rotary separator 130. The rotary separator can be inclined at an angle from horizontal between 5° and 75°, 10° and 60°, 15° and 50°, 20° and 45°, 20° and 40°, 20° and 35°, and 25° and 30°. As depicted in FIG. 3, the lower discharge end of the inner filter tube 136 can extend beyond the lower discharge end of the outer housing 140. The ratio of the length of the inner filter tube 136 to the inner diameter of the inner filter tube 136 may be in a range of 100:1 to 50:1 to 40:1 to 30:1 to 20:1 to 10:1 to 5:1, or lower depending on the type of solid that occurs in the slurry that is being passed through the inner filter tube 136 of the rotary separator 130. The inner filter tube 136 is configured for driven rotation by a motor or motorized wheels 142. The rotary separator 130 is designed to be able to operate on a continuous or substantially continuous basis when a slurry is being delivered to the inner filter tube 136.

The liquid-solid ICL-ice slurry is fed through the inlet 144 into the interior of the inner filter tube 136. As the slurry falls through the rotating inner filter tube 136, the liquid ICL drains through the mesh wall 138 and is collected along the inner surface of the outer housing 140. The collected liquid ICL drains down the outer housing 140 to the ICL recovery tank 132. Meanwhile, the solid ice particles that are larger than the mesh size of the mesh wall 138 are captured within the inner filter tube 136. As the inner filter tube 136 continues to rotate, the ice particles are encouraged to travel down the inner filter tube 136, as depicted in FIG. 4. The ice particles are ultimately deposited out of the lower open end of the inner filter tube 136 into the ice recovery tank 134.

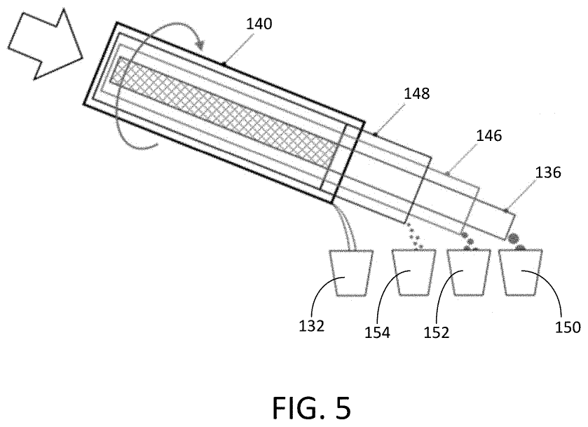

The rotary separator depicted in FIG. 3 is a two-stage separator in which liquids are directed into the ICL recovery tank 132 and solids larger than the mesh size of the mesh wall 138 are filtered into the ice recovery tank 134. In another embodiment, the rotary separator 130 is configured as a multi-stage separator that is capable of effectively discriminating between solids of varying sizes. In this configuration, as shown in FIG. 5, two or more filter tubes with filter materials having different aperture or pore sizes can be employed inside one another. The innermost filter has the largest (coarsest) openings and the outer most filter has the smallest (finest) openings. The inner filter tube 136 (the innermost filter) collects the largest solid particles and permits the liquid and small and medium-sized solid particles to pass into an intermediate filter tube 146. The large particles trapped within the inner filter tube 136 are deposited into a large particle tank 150. In a similar way, the intermediate filter tube 146 collects the medium-sized particles released from the inner filter tube 136 and permits the liquid and the smallest solid particles to pass into an outer filter tube 148. The medium-sized particles are deposited by the intermediate filter tube 146 into a medium particle tank 152. Finally, the outer filter tube 148 collects the finest solid particles and allows only the liquid to pass through into the outer housing 140. The outer filter tube 148 deposits the smallest particles into a small particle tank 154. To accommodate the adjacent placement of the large particle tank 150, medium particle tank 152 and small particle tank 154, the inner filter tube 136 (course mesh filter) extends beyond the intermediate filter tube 146 (medium mesh filter), which in turn extends beyond the outer filter tube 148 (fine mesh filter). Additional filter tubes and receptacles can be employed to have a more refined classification of solids.

The length of the separation apparatus can vary from a few millimeters to several meters depending on the diameter of the filter tube(s). In general, the length is at least 10 times larger than the diameter of the inner filter tube. The longer the filter tube is, the less wet the separated solid particles are due to the larger residence time inside the filter. The diameter of the inner filter tube can vary from a few millimeters up to a few meters.

In certain embodiments, the rotary separator 130 can be divided in two or more segments along its axial length. The segments are serially connected and the solid and liquid move directly from the upstream segment to the downstream segment. However, each segment can spin with a different rotation speed compared to the other segment. The large rotational speeds can be used to remove more liquid from the separated solid by the centrifugal action. After “drying” the rotational speed can be decreased to enable the downward motion of the collected solids and their collection at the exit of the tube.

In a non-limiting embodiment, the rotary separator 130 can be used in a centralized plant to produce the final product, e.g., desalinated water. Several factors make a centralized plant design particularly useful. The main factor is that the system described herein creates a stream of highly concentrated brine. The most reliable way of disposal of this brine is deep well injection. A centralized plant with easy access to an injection well eliminates the cost associated with transportation of the concentrated brine to the disposal site. Furthermore, there is already a significant infrastructure developed for handling produced water. Two primary services are provided by the existing facilities, (i) disposal, mainly by injection into the ground, and (ii) supplying water to the producers for fracking operation and enhanced oil recovery. By positioning our desalination system within the existing facilities, both services offered can be improved. On the disposal side, significant reduction in the amount of the injected produced water helps to operators to meet the regulations and prolongs the well lifetime. Regarding the water supply to users, the improved quality of the output water expands the list of potential users and buyers. Currently, only the oil and gas producers use a fraction of the treated produced water. The desalinated water from the disclosed system can be used in much broader industrial and agricultural applications. At the same time, having access to an existing plant we can benefit from the water gathering system and the produced water storage facilities already in place. Nevertheless, the separation system described herein can be fit into a portable container and used for mobile applications if disposal needs for the rejected high concentration brine and access to affordable electricity are provided. Such a mobile system is particularly attractive if there is demand for the desalinated water close to the site of produced water generation.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

It is claimed:

1. A water treatment system for removing salt from a feed brine, the water treatment system comprising:
a primary freezing chamber configured to receive the feed brine;
a source of cooled intermediate cold liquid connected to the primary freezing chamber, wherein the cooled intermediate cold liquid and feed brine are mixed within the primary freezing chamber; and
a rotary separator connected to a discharge from the primary freezing chamber, wherein the rotary separator is configured to separate solid ice particles from liquid components in the discharge from the primary freezing chamber.

2. The water treatment system of claim 1, wherein the primary freezing chamber includes a nozzle configured to spray the feed brine in the primary freezing chamber.

3. The water treatment system of claim 2, wherein the primary freezing chamber includes a headspace above a liquid column and wherein the nozzle is configured to spray the feed brine into the headspace.

4. The water treatment system of claim 1, wherein the rotary separator comprises:
an outer housing; and
an inner filter tube configured to rotate within the outer housing, wherein the inner filter tube includes a mesh wall with a mesh size that permits liquid to pass through the inner filter tube into the outer housing.

5. The water treatment system of claim 4, wherein the rotary separator further comprises an ICL recovery tank configured to receive a liquid stream collected by the outer housing.

6. The water treatment system of claim 5, wherein the rotary separator further comprises an ice recovery tank configured to receive solid ice particles discharged from the inner filter tube.

7. The water treatment system of claim 4, wherein the rotary separator further comprises:
an outer filter tube inside the outer housing, wherein the outer filter tube has a mesh wall with a first mesh size;
an intermediate filter tube inside the outer filter tube, wherein the intermediate filter tube has a mesh wall with a second mesh size that is larger than the first mesh size; and
wherein the inner filter tube is located inside the intermediate filter tube, and wherein the mesh size of the mesh wall on the inner filter tube is larger than the second mesh size.

8. The water treatment system of claim 7, wherein the rotary separator further comprises a motor configured to rotate the inner filter tube, the intermediate filter tube and the outer filter tube within the outer housing.

9. The water treatment system of claim 4, wherein the rotary separator further comprises motorized wheels that are configured to rotate the inner filter tube within the outer housing.

10. The water treatment system of claim 1, further comprising an ice grinder connected to the primary freezing chamber and configured to reduce the size of any ice particles leaving the primary freezing chamber.

11. A water treatment system for removing salt from a feed brine, the water treatment system comprising:
a primary freezing chamber configured to receive the feed brine;
a source of cooled intermediate cold liquid connected to the primary freezing chamber, wherein the cooled intermediate cold liquid and feed brine are mixed within the primary freezing chamber; and
a rotary separator connected to a discharge from the primary freezing chamber, wherein the rotary separator is configured to separate solid ice particles from liquid components in the discharge from the primary freezing chamber, and wherein the rotary separator comprises:
an outer housing; and
a plurality of inner filter tubes each configured to rotate within the outer housing, wherein each of the plurality of inner filter tubes includes a mesh wall with a unique mesh size that selectively separates liquids and ice particles based on the unique mesh size of each of the plurality of inner filter tubes.

12. The water treatment system of claim 11, wherein the primary freezing chamber includes a nozzle configured to spray the feed brine in the primary freezing chamber.

13. The water treatment system of claim 12, wherein the primary freezing chamber includes a headspace above a liquid column and wherein the nozzle is configured to spray the feed brine into the headspace.

14. The water treatment system of claim 13, wherein the rotary separator further comprises an ICL recovery tank configured to receive a liquid stream collected by the outer housing.

15. The water treatment system of claim 14, wherein the rotary separator further comprises an ice recovery tank configured to receive solid ice particles discharged from the inner filter tube.

16. The water treatment system of claim 15, wherein the rotary separator further comprises a motor configured to rotate the plurality of inner filter tubes within the outer housing.

17. The water treatment system of claim 11, further comprising an ice grinder connected to the primary freezing chamber and configured to reduce the size of any ice particles leaving the primary freezing chamber.

18. A water treatment system for removing salt from a feed brine, the water treatment system comprising:
a primary freezing chamber configured to receive the feed brine;
a source of cooled intermediate cold liquid connected to the primary freezing chamber, wherein the cooled intermediate cold liquid and feed brine are mixed within the primary freezing chamber; and
means for separating solid ice particles from liquid components in the discharge from the primary freezing chamber.

19. The water treatment system of claim 18, wherein the primary freezing chamber includes a nozzle configured to spray the feed brine in the primary freezing chamber.

20. The water treatment system of claim 18, further comprising an ice grinder connected to the primary freezing chamber and configured to reduce the size of any ice particles leaving the primary freezing chamber.
